(19) United States
(12) Patent Application Publication
(10) Pub. No.: US 2013/0173361 A1
(43) Pub. Date: Jul. 4, 2013

(54) METHOD AND APPARATUS FOR PROVIDING ADVERTISEMENT REWARD

(71) Applicant: KT CORPORATION, Seongnam (KR)

(72) Inventors: Eui-Seung SON, Incheon (KR); Won-Yeol LEE, Seoul (KR); Eun-Kyoung PAIK, Seongnam-si (KR)

(73) Assignee: KT CORPORATION, Seongnam (KR)

(21) Appl. No.: 13/732,010

(22) Filed: Dec. 31, 2012

(30) Foreign Application Priority Data
Dec. 30, 2011 (KR) 10-2011-0147157

(51) Int. Cl. G06Q 30/02

(52) U.S. Cl. CPC G06Q 30/0207
USPC 705/14.1

(57) ABSTRACT

An advertisement reward providing method includes receiving first advertisement information associated with advertisement, that is being reproduced in a first device, from a second device, providing, to the second device, a mission associated with the advertisement based on the first advertisement information, receiving, from the second device, a mission completion message and providing an advertisement reward to at least one of the first device and the second device, in response to the mission completion message.

### CROSS-REFERENCE TO RELATED PATENT APPLICATION

This application claims priority from the Korean Patent Application No. 10-2011-0147157, filed on Dec. 30, 2011 in the Korean Intellectual Property Office, the entire disclosure of which is incorporated herein by reference in its entirety.

### BACKGROUND

1. Field

Exemplary embodiments broadly relate to a method and an apparatus for providing an advertisement reward.

2. Description of the Related Art

With the expanded propagation of broadcasting services having multiple channels such as Internet Protocol television (IPTV) and cable television (CATV), and the presence of the general programming channels, users can select and view various broadcasting contents.

As a result, the broadcasting advertisement market has greatly grown. However, users tend to avoid viewing advertisement contents, and do not concentrate on the advertisement contents, as they view other broadcasting contents during the advertisement time or enjoy web surfing, games, or other activities with another device.

As the concentration on advertisement contents is reduced, various research on inducing users to concentrate on the advertisement contents has been conducted. In particular, there have been attempts to provide certain advertisement rewards for viewing advertisements.

In this regard, a related art (Korean Patent Application Publication No. 2010-0006933) describes a system and a method for identifying advertisement by using a bi-directional device capable of directly identifying whether a user is viewing an advertisement.

### SUMMARY

Accordingly, it is an aspect to provide a method and an apparatus for providing a reward, by receiving, from a second device, an advertisement information associated with an advertisement being reproduced in a first device, providing a mission associated with the advertisement to the second device, and receiving a mission completion message corresponding to the mission from the second device to provide a certain reward.

Another aspect is to provide a method of receiving a reward, by generating image data associated with an advertisement, transmitting image data and time information associated with the image data to an apparatus, receiving a mission associated with the advertisement from the apparatus, and receiving a certain advertisement reward for the completion of the mission from the apparatus.

According to an aspect of exemplary embodiments, there is provided a method of providing a reward. The method includes receiving first advertisement information associated with an advertisement, that is being reproduced in a first device, from a second device, providing, to the second device, a mission associated with the advertisement based on the first advertisement information, receiving, from the second device, a mission completion message and providing the reward to at least one of the first device and the second device, in response to the mission completion message.

The first advertisement information may comprise at least one from among image data associated with the advertisement and time information associated with the image data.

The first advertisement information may comprise identification information of the first device.

The providing the mission associated with the advertisement may comprise: obtaining second advertisement information based on the at least one from among the image data and the time information associated with the image data; and providing, to the second device, the mission corresponding to the second advertisement information.

The providing the mission associated with the advertisement may comprise: obtaining second advertisement information associated with the advertisement corresponding to the identification information of the first device; and providing, to the second device, the mission corresponding to the second advertisement information.

The mission may comprise image information related to one from among advertisement goods and advertisement services associated with the advertisement.

The reward may be provided with reference to at least one from among identification information of the first device and identification information of the second device.

According to another aspect of exemplary embodiments, a reward providing apparatus includes a first receiver configured to receive first advertisement information associated with an advertisement that is being reproduced in a first device, from a second device, a first provider configured to provide, to the second device, a mission associated with the advertisement based on the first advertisement information, a second receiver configured to receive, from the second device, a mission completion message and a second provider configured to provide the reward to at least one from among the first device and the second device, in response to the mission completion message.

The first advertisement information may comprise at least one from among image data associated with the advertisement and time information associated with the image data, and the first provider is further configured to obtain second advertisement information based on the at least one from among the image data and the time information associated with the image data, and to provide, to the second device, the mission corresponding to the second advertisement information.

The first advertisement information may comprise identification information of the first device, and the first provider is further configured to obtain second advertisement information associated with the advertisement corresponding to the identification information of the first device, and to provide, to the second device, the mission corresponding to the second advertisement information.

The reward may be provided with reference to at least one from among identification information of the first device and identification information of the second device.

The apparatus may further comprise a database configured to store the mission completion message; and a manager configured to manage advertisement target information based on the stored mission completion message.

According to another aspect of exemplary embodiments, there is provided a method of receiving a reward. The method includes generating image data associated with an advertisement that is being reproduced on a reproduction device, transmitting, to an apparatus, the generated image data and time information of the image data, receiving a mission associated with the advertisement from the advertisement reward providing apparatus, transmitting, to the apparatus, a mission completion message with respect to one from among advertisement goods and services associated with the advertisement and receiving, from the apparatus, the reward.

The mission completion message may comprise at least one from among: advertisement information associated with the one from among advertisement goods and services, identification information of a user device, and meta information about the one from among advertisement goods and services.

The transmitting the mission completion message may comprise: displaying, on an area of a screen of the user device, the one from among the advertisement goods and services; extracting image data for the one from among advertisement goods and services displayed on the area; and transmitting, to the apparatus, the mission completion message comprising the extracted image data.

The meta information about the one from among the advertisement goods and services may comprise at least one from among a phone number, an e-mail address, and a serial number associated with the one from among advertisement goods and services.

The image data associated with the advertisement may be generated by capturing an image of the advertisement that is being reproduced, by a screen capture application.

According to another aspect of exemplary embodiments, a device includes a generator configured to generate image data associated with an advertisement that is being reproduced on a reproduction device, a first transmitter configured to transmit, to an apparatus, the generated image data and time information related to the image data, a first receiver configured to receive a mission associated with the advertisement from the apparatus, a second transmitter configured to transmit, to the apparatus, a mission completion message related to one from among advertisement goods and services associated with the advertisement and a second receiver configured to receive, from the apparatus, a reward.

According to aspect of an exemplary embodiment, the image data may be generated by executing a reward application and capturing an image of the advertisement through the executed reward application.

According to aspect of an exemplary embodiment, the identification information may be used to identify the advertisement.

According to aspect of an exemplary embodiment, an apparatus stores, renews, and manages advertisement information.

According to aspect of an exemplary embodiment, the first advertisement information comprises information of a user.

According to aspect of an exemplary embodiment, the operations of the method of receiving a reward are performed sequentially in order.

In an exemplary embodiment, there is provided a system for providing a reward. The system comprises: a first device which reproduces an advertisement; a second device which transmits advertisement information based on the advertisement being reproduced by the first device; and a third device for providing the reward, the third device comprising: a first receiver configured to receive first advertisement information associated with the advertisement that is being reproduced in the first device, from the second device; a first provider configured to provide, to the second device, a mission associated with the advertisement, based on the advertisement information; a second receiver configured to receive, from the second device, a mission completion message; and a second provider configured to provide the reward to at least one from among the first device and the second device, in response to the mission completion message.

In exemplary embodiments, there is a method and an apparatus for providing a reward by receiving advertisement information associated with an advertisement being reproduced in a first device from a second device, providing a mission associated with the advertisement to the second device, and receiving a mission completion message corresponding to the mission from the second device to provide a certain advertisement reward.

Further, an aspect of exemplary embodiments may provide a method of receiving a reward by generating image data associated with an advertisement, transmitting the image data and time information associated with the image data to an apparatus, receiving a mission associated with the advertisement from the apparatus, transmitting a mission completion message corresponding to the mission to the apparatus, and receiving a certain advertisement reward for the completion of the mission from the apparatus.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not intended to limit its scope, the exemplary embodiments will be described with specificity and detail taken in conjunction with the accompanying drawings, in which:

FIG. 1 is a view illustrating a configuration of an advertisement reward providing system according to an exemplary embodiment;

FIG. 2 is an example diagram illustrating the advertisement reward providing system according to an exemplary embodiment;

FIG. 3 is a block diagram illustrating a second device according to an exemplary embodiment;

FIG. 4 is an exemplary view illustrating a movement of advertisement goods in relation to a lapse of time according to an exemplary embodiment;

FIG. 5 is an exemplary view illustrating an example of a mission completion process on a screen of a second device according to an exemplary embodiment;

FIG. 6 is a block diagram illustrating an advertisement reward providing apparatus according to an exemplary embodiment;

FIG. 7 is a flow diagram illustrating an advertisement reward receiving method according to an exemplary embodiment; and

FIG. 8 is a flow diagram illustrating an advertisement reward providing method according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

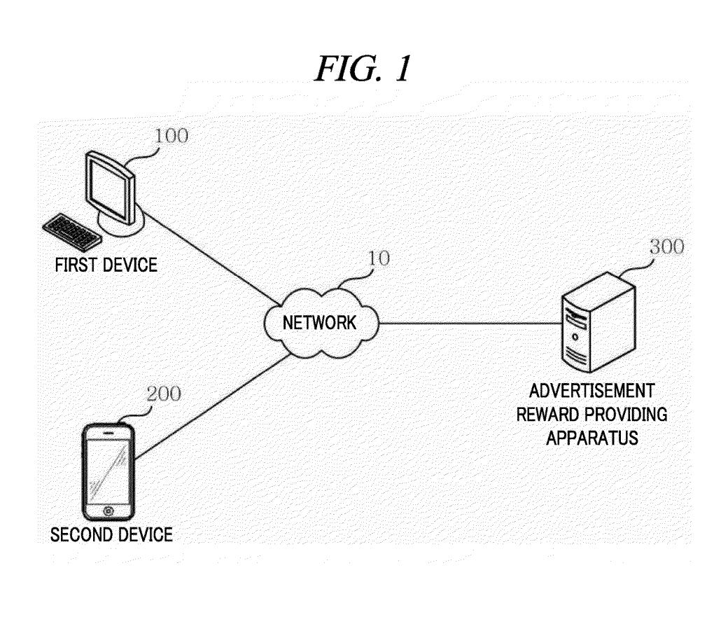

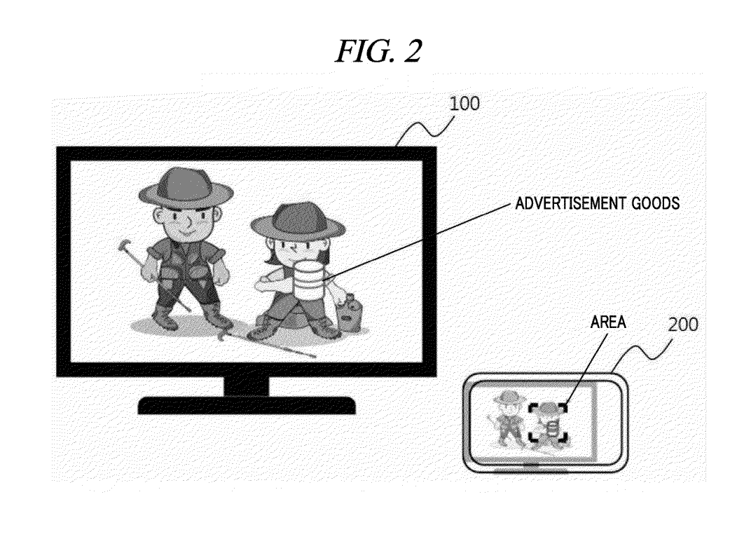

FIG. 1 is a view illustrating a configuration of an advertisement reward providing system according to an exemplary embodiment. FIG. 2 is an exemplary diagram illustrating the advertisement reward providing system according to an exemplary embodiment.

The advertisement reward providing system according to an exemplary embodiment may include a first device 100, a second device 200, and an advertisement reward providing apparatus 300, which are connected to a network 10.

The network 10 may be embodied by any types of wired and wireless networks such as a local area network (LAN), a wide area network (WAN), a value added network (VAN), a personal area network (PAN), a mobile radio communication network, or a satellite communication network.

The first device 100 and the second device 200 may be connected to a remote server through the network 10 or embodied by a computer, a mobile device, or a television that can be connected to another device and a server. Here, the computer may include, for example, a notebook provided with a WEB Browser, a desktop, a laptop, and others. The mobile device is, for example, a wireless communication device assuring portability and mobility and may include any types of handheld-based wireless communication devices such as a personal communication system (PCS), global system for mobile communications (GSM), personal digital cellular (PDC), personal handy phone system (PHS), personal digital assistant (PDA), international mobile telecommunication (IMT)-2000, code division multiple access (CDMA)-2000, W-code division multiple access (W-CDMA), a wireless broadband Internet (Wibro) device, and a smart phone. The television may include the Internet protocol television (IPTV), an Internet television (Internet TV), a terrestrial TV, and a cable TV.

With reference to the example in FIG. 2, the first device 100 may be a reproduction device, such as, a TV. The second device 200 may be a user device, such as, a smart phone. A user may view broadcasting contents and an advertisement through the first device 100, and carry out activities associated with acquisition of an advertisement reward by using the second device 200. For example, the user may capture an image of the advertisement that is being reproduced on the TV, which is the first device 100, by using the smart phone, which is the second device 200, and carry out a certain mission by using the smart phone to receive an advertisement reward.

The advertisement reward providing apparatus 300 is connected to the first device 100 and the second device 200 through the network 10. The advertisement reward providing apparatus 300 may provide the advertisement to the first device 100 or the second device 200, or both the first device 100 and the second device 200.

The advertisement reward providing apparatus 300 may provide the first device 100 or the second device 200 with a mission to provide an advertisement reward, receive a mission completion message from the first device 100 or the second device 200, and provide a certain advertisement reward to the first device 100 or the second device 200 that has successfully completed the mission.

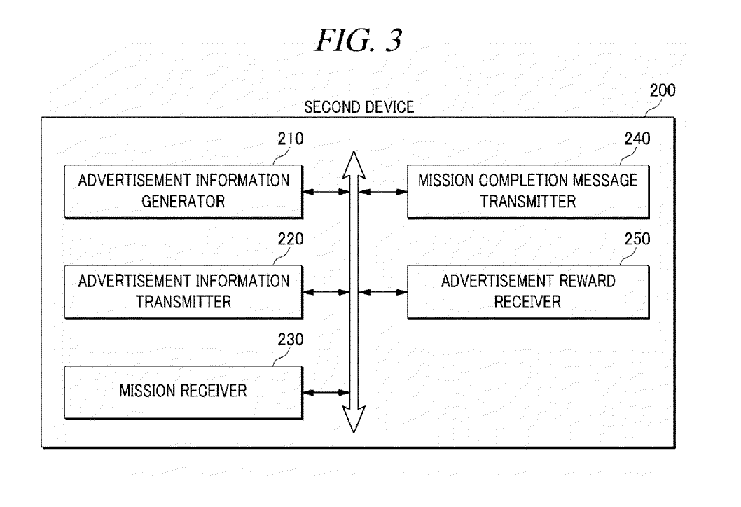

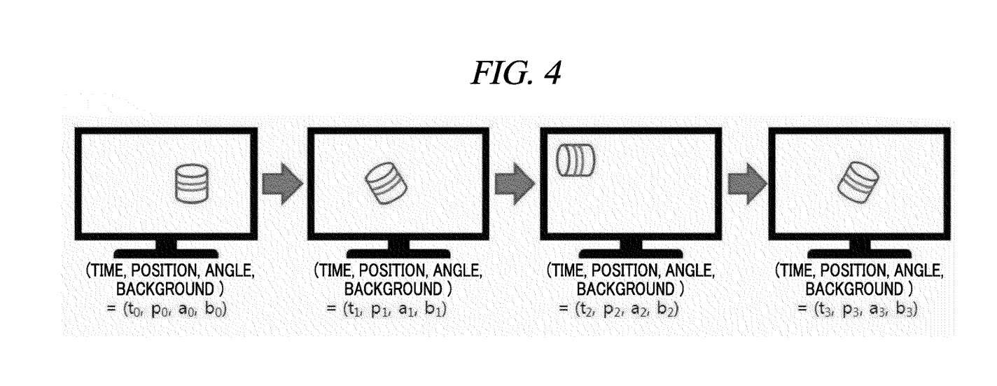

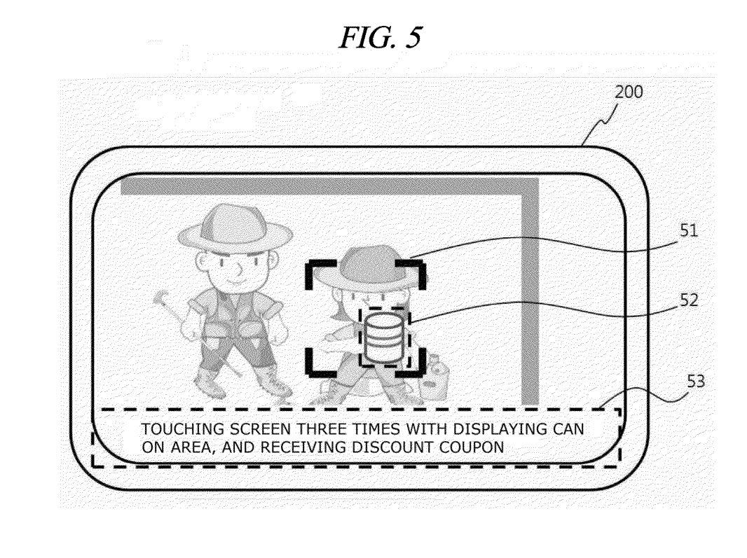

FIG. 3 is a block diagram illustrating a second device according to an exemplary embodiment. FIG. 4 is an exemplary view illustrating a movement of advertisement goods as time lapses, according to an exemplary embodiment. FIG. 5 is an exemplary view illustrating an example of a mission completion process on a screen of a second device according to an exemplary embodiment.

A second device 200 according to an exemplary embodiment may include an advertisement information generator 210, an advertisement information transmitter 220, a mission receiver 230, a mission completion message transmitter 240, and an advertisement reward receiver 250. The second device 200 may also include a processor configured to perform various operations of the second device 200 as described below and a memory which stores information and/or data.

The advertisement information generator 210 generates image data associated with an advertisement that is being reproduced on a first device.

For example, the second device 200 may generate the image data by capturing an image of the advertisement that is being reproduced by a screen capture application. Otherwise, the second device 200 may generate the image data by executing an advertisement reward application and capturing the image of the advertisement through the executed advertisement reward application.

According to an exemplary embodiment, the advertisement information transmitter 220 transmits the image data and time information associated with the image data to the advertisement providing device 300.

Here, the time information associated with the image data may include advertisement reproduction time when the image of the advertisement is captured.

According to another exemplary embodiment, the advertisement information transmitter 220 may transmit identification information of the first device.

Here, the identification information may be, for example, used to identify the advertisement being reproduced on the first device by the advertisement reward providing apparatus 300. The advertisement reward providing apparatus 300 may store, renew, and manage the advertisement information to be provided to the first device according to the identification information.

The mission receiver 230 receives a mission associated with the advertisement from the advertisement reward providing apparatus 300.

Here, the mission may include image information of advertisement goods or advertisement services associated with the advertisement.

Here, the image information enables the second device 200 to rapidly and efficiently extract image data of the advertisement goods or advertisement services. For example, the image information may include an image finger print, an image mask, or other similar items which assist in extraction of image data.

As illustrated in FIG. 4, the second device 200 may be provided with information of a position “p”, an angle “a”, a background image “b”, and other information related to the advertisement goods or advertisement services shown in the advertisement as the advertisement goods or advertisement services moves along with the lapse of an advertisement reproduction time “t”. That is, the advertisement reward providing apparatus 300 may provide, in advance, the image information of the advertisement goods or advertisement services as a function of time, to the second device 200. The second device 200 may execute an image data extraction by using the image information corresponding to each time so that the image data of the advertisement goods or advertisement services can be more rapidly and efficiently extracted.

According to an exemplary embodiment, in order to enable the second device 200 to extract an image data of the advertisement goods or advertisement services, it is possible to provide only an image finger printer or image mask information for the advertisement goods or advertisement services of the second device 200, so that network traffic and the load of the advertisement reward providing apparatus 300 can be reduced.

Based on the mission, the mission completion message transmitter 240 transmits a mission completion message with respect to the advertisement goods or advertisement services associated with the advertisement to the advertisement reward providing apparatus 300.

The mission completion message transmitter 240 may include a mission executor (not illustrated). The mission executor may generate the mission completion message of the second device 200 corresponding to the mission. For example, the advertisement goods or advertisement services may be displayed on an area of a display screen of the second device 200, image data of the advertisement goods or advertisement services displayed on the area may be extracted, and the mission completion message including the extracted image data may be transmitted to the advertisement reward providing apparatus 300.

With reference to FIG. 5, the user may position the advertisement goods or advertisement services 52 within the area 51 of the display screen of the second device 200, and for example, press a button of the second device 200 or touch a screen thereof to extract an image data of the advertisement goods or advertisement services. Also, the user may carry out a mission 53 associated with the advertisement.

As illustrated in FIG. 5, for example, the mission executor may provide a mission which includes acquiring an image data of the advertisement goods or advertisement services 52 at least the specific number of times, as indicated in the mission 53. If the image of the advertisement goods or advertisement services 52 is extracted at least three times, the mission may be determined to have been successfully completed.

According to an exemplary embodiment, if a match rate of the extracted image data and the original image of the advertisement goods or advertisement services is more than a preset threshold, the second device 200 may determine the completion of the mission by itself or transmit the extracted image data to the advertisement reward providing apparatus 300 to determine the completion of the mission by the advertisement reward providing apparatus 300.

In an exemplary embodiment, the advertisement goods or advertisement services 52 is displayed on the area 51 of the display screen of the second device 200, and image processing is performed only for the area by using the image information, so that the load of the second device 200 can be reduced, and the mission can be rapidly and efficiently completed. Furthermore, the user may be provided with fun elements in the process for carrying out the mission such as positioning the advertisement goods or advertisement services 52 within the area 51. As a result, there is an effect in naturally improving the concentration on the advertisement.

For example, the user may carry out a mission by storing at least one meta information including at least one of a phone number, an e-mail address, and a serial number associated with the advertisement goods or advertisement services. The second device 200 may transmit the mission completion message, including the meta information, to the advertisement reward providing apparatus 300. Further, the mission completion message may include at least one of advertisement information associated with the advertisement goods or services, identification information of a second device, and meta information about the advertisement goods or services.

Based on the mission completion message, the advertisement reward receiver 250 receives the advertisement reward from the advertisement reward providing apparatus 300.

Here, the advertisement reward may be, for example, a discount coupon of the advertisement goods or advertisement services, a discount coupon of another product, cyber money, a gift card, a mobile gift card, a gift show, cash, or other rewards.

According to an exemplary embodiment, the advertisement information generator 210, the advertisement information transmitter 220, the mission receiver 230, the mission completion message transmitter 240, and the advertisement reward receiver 250 may be included in an advertisement reward application. The user may carry out a series of activities by executing the advertisement reward application in the second device 200.

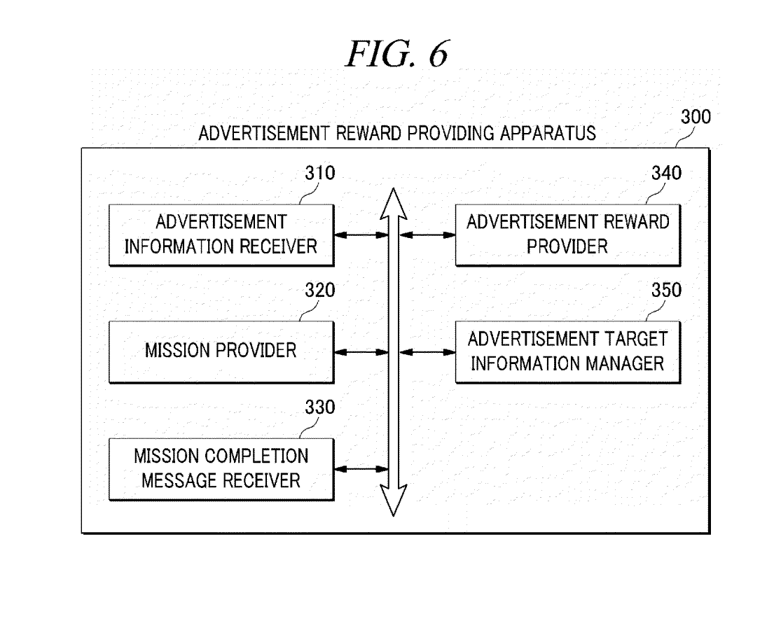

FIG. 6 is a block diagram illustrating an advertisement reward providing apparatus according to an exemplary embodiment.

The advertisement reward providing apparatus 300 according to an exemplary embodiment may include an advertisement information receiver 310, a mission provider 320, a mission completion message receiver 330, an advertisement reward provider 340, and an advertisement target information manager 350.

According to an exemplary embodiment, the advertisement reward providing apparatus 300 may be included in a broadcasting service system (not illustrated). The broadcasting service system may provide broadcasting contents to the first device 100, and provide advertisement at a certain time point.

The advertisement information receiver 310 receives first advertisement information associated with advertisement that is being reproduced on the first device 100 from the second device 200.

Here, the first advertisement information means information, from which the advertisement reward providing apparatus 300 can determine the advertisement being reproduced in the first device. For example, the first advertisement information may include image data associated with the advertisement and time information associated with the image data, or identification information of the first device.

Based on the first advertisement information, the mission provider 320 provides the mission associated with the advertisement to the second device 200.

Based on the image data and the time information associated with the image data, the mission provider 320 may obtain second advertisement information, and provide the mission corresponding to the second advertisement information to the second device 200.

Here, the second advertisement information means information associated with the advertisement identified by the advertisement reward providing apparatus 300 based on the first advertisement information. Based on the image data and the time information associated with the image data, the advertisement reward providing apparatus 300 may determine the advertisement that is being reproduced on the first device.

The mission provider 320 may obtain second advertisement information associated with the advertisement by using the identification information of the first device, and provide the mission corresponding to the second advertisement information to the second device.

The advertisement reward providing apparatus 300 may store, renew, and manage the advertisement information associated with the advertisement to be provided to the device, in a database. The advertisement reward providing apparatus 300 may obtain the second advertisement information by using the identification information of the first device, for example, from the database.

According to an exemplary embodiment, the mission may include image information of the advertisement goods or advertisement services associated with the advertisement.

The mission receiver 330 receives a mission completion message corresponding to the mission from the second device 200.

Based on the mission completion message, the advertisement reward provider 340 provides an advertisement reward to at least one of the first device 100 and the second device 200.

The advertisement reward provider 340 may provide an advertisement reward with reference to at least one of the identification information of the first device 100 and the identification information of the second device 200.

Here, the identification information may be unique information of a device, from which the first device 100 and the second device 200 can be identified, or unique information of a user, from which users of the first device 100 and the second device 200 can be identified.

The advertisement target information manager 350 stores the mission completion message in a database (not illustrated). Based on the mission completion message stored in the database, the advertisement target information manager 350 manages advertisement target information.

The advertisement target information manager 350 analyzes for which advertisement the user has received an advertisement reward, to provide preference analysis results to an advertiser. By using the preference analysis results, when a product preferred by the user is being advertised, the advertisement target information manager 350 may provide the corresponding information to the second device 200.

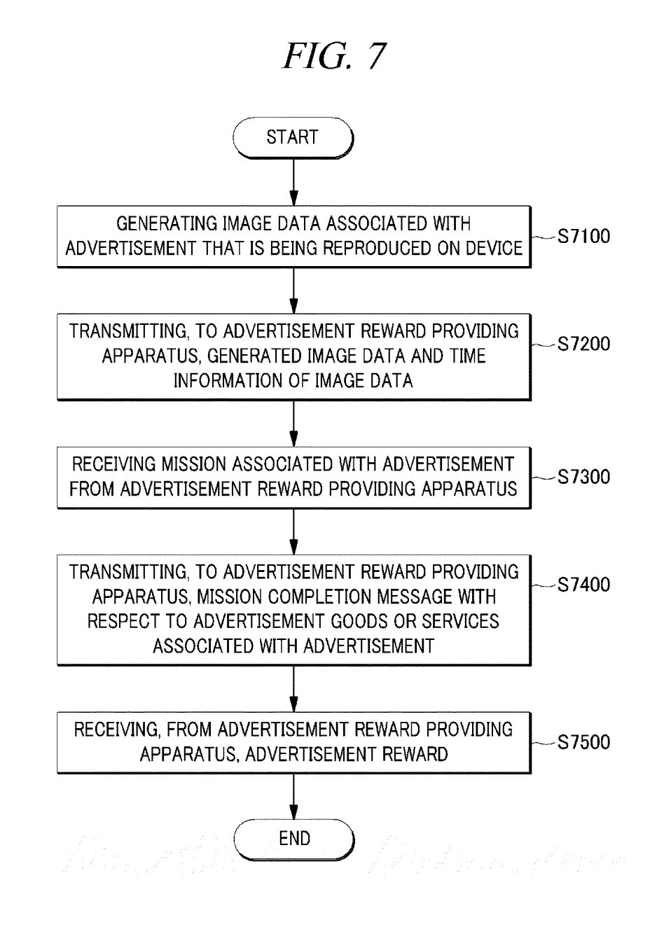

FIG. 7 is a flow diagram illustrating an advertisement reward receiving method according to an exemplary embodiment.

An advertisement reward receiving method according to the example illustrated in FIG. 7 includes operations sequentially processed in the second device 200 illustrated in FIG. 3. Accordingly, the descriptions of the second device 200 illustrated in FIG. 3, even though the descriptions are not provided below, may be applied to the advertisement reward receiving method according to the example illustrated in FIG. 7.

In operation S7100, the second device 200 generates image data associated with advertisement being reproduced on the first device.

The image data associated with advertisement is generated by capturing an image of the advertisement that is being reproduced, by a screen capture application.

In operation S7200, the second device 200 transmits the generated image data and time information of the image data to the advertisement reward providing apparatus.

In operation S7300, the second device 200 receives a mission associated with the advertisement from the advertisement reward providing apparatus.

In operation S7400, based on the mission, the second device 200 transmits a mission completion message with respect to an advertisement goods or advertisement services associated with the advertisement to the advertisement reward providing apparatus.

S7400 may include an operation of displaying the advertisement goods or advertisement services on an area of a display screen of the second device, an operation of extracting the image data for the advertisement goods or advertisement services displayed on the area, and an operation of transmitting the mission completion message including the extracted image data to the advertisement reward providing apparatus.

S7400 may store meta information about the advertisement goods or services including at least one of a phone number, an e-mail address, and a serial number associated with the advertisement goods or advertisement services included in the advertisement.

In operation S7500, based on the mission completion message, the second device 200 receives an advertisement reward from the advertisement reward providing apparatus.

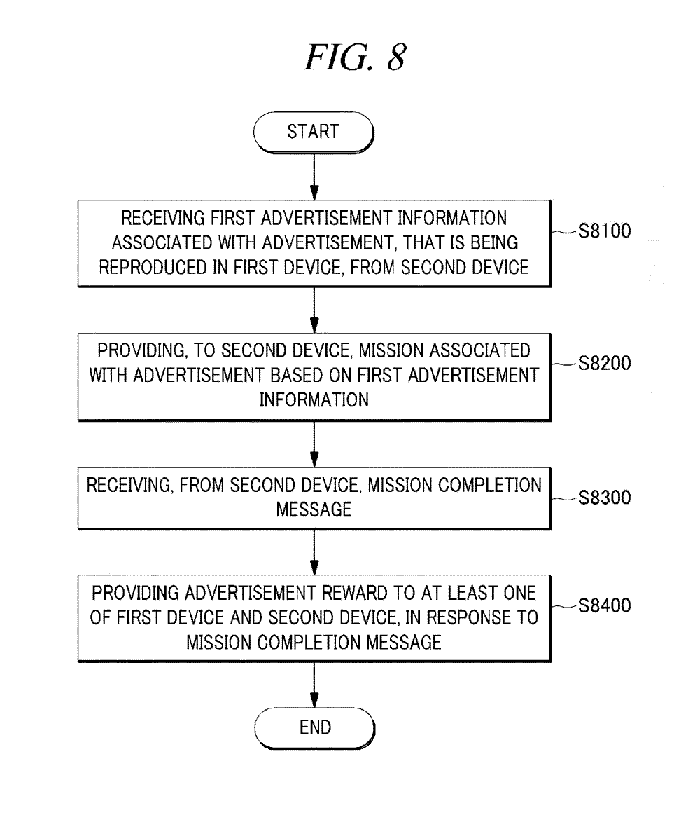

FIG. 8 is a flow diagram illustrating an advertisement reward providing method according to an exemplary embodiment.

The advertisement reward providing method according to the example illustrated in FIG. 8 includes operations sequentially processed in the advertisement reward providing apparatus 300 illustrated in FIG. 6. Accordingly, the descriptions of the advertisement reward providing apparatus 300 illustrated in FIG. 6, even though the descriptions are not provided below, may be applied to the advertisement reward providing method according to the example illustrated in FIG. 8.

In operation S8100, the advertisement reward providing apparatus 300 receives first advertisement information associated with the advertisement that is being reproduced on the first device, from the second device.

In operation S8200, the advertisement reward providing apparatus 300 provides a mission associated with the advertisement to the second device, based on the first advertisement information.

The operation S8200 may include an operation of obtaining second advertisement information, based on the image data and the time information associated with the image data, and an operation of providing the mission corresponding to the second advertisement information to the second device.

S8200 may include an operation of obtaining second advertisement information associated with the advertisement corresponding to the identification information of the first device, and an operation of providing the mission corresponding to the second advertisement information to the second device.

The advertisement reward providing apparatus 300 may store, renew, and manage advertisement information associated with the advertisement to be provided to the device, in a database. The advertisement reward providing apparatus 300 may obtain the second advertisement information by using the identification information of the first device, for example, from the database.

In operation S8300, the advertisement reward providing apparatus 300 receives a mission completion message corresponding to the mission from the second device.

In operation S8400, in response to the mission completion message, the advertisement reward providing apparatus 300 provides an advertisement reward to at least one of the first device and the second device.

S8400 may include an operation of providing an advertisement reward, with reference to at least one of the identification information of the first device and the identification information of the second device.

Exemplary embodiments may be embodied in a transitory or non-transitory storage medium which includes instruction codes which are executable by a computer or processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of the exemplary embodiments. Thus, above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method of providing a reward, the method comprising:
receiving first advertisement information associated with an advertisement that is being reproduced in a first device, from a second device;
providing, to the second device, a mission associated with the advertisement based on the first advertisement information;
receiving, from the second device, a mission completion message; and
providing the reward to at least one of the first device and the second device, in response to the mission completion message.

2. The method of claim 1, wherein the first advertisement information comprises at least one from among image data associated with the advertisement and time information associated with the image data.

3. The method of claim 1, wherein the first advertisement information comprises identification information of the first device.

4. The method of claim 2, wherein the providing the mission associated with the advertisement comprises:
obtaining second advertisement information based on the at least one from among the image data and the time information associated with the image data; and
providing, to the second device, the mission corresponding to the second advertisement information.

5. The method of claim 3, wherein the providing the mission associated with the advertisement comprises:
obtaining second advertisement information associated with the advertisement corresponding to the identification information of the first device; and
providing, to the second device, the mission corresponding to the second advertisement information.

6. The method of claim 1, wherein the mission comprises image information related to one from among advertisement goods and advertisement services associated with the advertisement.

7. The method of claim 1, wherein the reward is provided with reference to at least one from among identification information of the first device and identification information of the second device.

8. An apparatus comprising:
a first receiver configured to receive first advertisement information associated with an advertisement that is being reproduced in a first device, from a second device;
a first provider configured to provide, to the second device, a mission associated with the advertisement, based on the first advertisement information;
a second receiver configured to receive, from the second device, a mission completion message; and
a second provider configured to provide the reward to at least one from among the first device and the second device, in response to the mission completion message.

9. The apparatus of claim 8, wherein the first advertisement information comprises at least one from among image data associated with the advertisement and time information associated with the image data, and
the first provider is further configured to obtain second advertisement information based on the at least one from among the image data and the time information associated with the image data, and to provide, to the second device, the mission corresponding to the second advertisement information.

10. The apparatus of claim 8, wherein the first advertisement information comprises identification information of the first device, and the first provider is further configured to obtain second advertisement information associated with the advertisement corresponding to the identification information of the first device, and to provide, to the second device, the mission corresponding to the second advertisement information.

11. The apparatus of claim 8, wherein the reward is provided with reference to at least one from among identification information of the first device and identification information of the second device.

12. The apparatus of claim 8, further comprising:
a database configured to store the mission completion message; and
a manager configured to manage advertisement target information based on the stored mission completion message.

13. A method of receiving a reward, the method comprising:
generating image data associated with an advertisement that is being reproduced on a reproduction device;
transmitting, to an apparatus, the generated image data and time information of the image data;
receiving a mission associated with the advertisement from the apparatus;
transmitting, to the apparatus, a mission completion message with respect to one from among advertisement goods and services associated with the advertisement; and
receiving, from the apparatus, the reward.

14. The method of claim 13, wherein the mission completion message comprises at least one from among: advertisement information associated with the one from among advertisement goods and services, identification information of a user device, and meta information about the one from among advertisement goods and services.

15. The method of claim 13, wherein the transmitting the mission completion message comprises:
displaying, on an area of a screen of the user device, the one from among the advertisement goods and services;
extracting image data for the one from among advertisement goods and services displayed on the area; and
transmitting, to the apparatus, the mission completion message comprising the extracted image data.

16. The method of claim 14, wherein the meta information about the one from among the advertisement goods and services comprises at least one from among a phone number, an e-mail address, and a serial number associated with the one from among advertisement goods and services.

17. The method of claim 13, wherein the image data associated with the advertisement is generated by capturing an image of the advertisement that is being reproduced, by a screen capture application.

18. A device comprising:
a generator configured to generate image data associated with an advertisement that is being reproduced on a reproduction device;
a first transmitter configured to transmit, to an apparatus, the generated image data and time information related to the image data;
a first receiver configured to receive a mission associated with the advertisement from the apparatus;
a second transmitter configured to transmit, to the apparatus, a mission completion message related to one from among advertisement goods and services associated with the advertisement; and
a second receiver configured to receive, from the apparatus, a reward.

19. The method of claim 2, further comprising generating the image data associated with the advertisement by executing a reward application and capturing an image of the advertisement through the executed reward application.

20. The apparatus of claim 9, wherein the image data is generated by executing a reward application and capturing an image of the advertisement through the executed reward application.

21. The method of claim 13, wherein the image data associated with the advertisement is generated by executing a reward application and capturing an image of the advertisement through the executed reward application.

22. The method of claim 3, wherein the identification information is used to identify the advertisement.

23. The apparatus of claim 10, wherein the identification information is used to identify the advertisement.

24. The apparatus of claim 8, wherein the apparatus stores, renews, and manages advertisement information.

25. The method of claim 5, wherein second advertisement information is obtained from a database.

26. The apparatus of claim 9, wherein the second advertisement information is obtained from a database.

27. The method of claim 1, wherein the first advertisement information comprises identification information of a user.

28. The apparatus of claim 8, wherein the first advertisement information comprises identification information of a user.

29. The method of claim 13, wherein the operations of the method are performed sequentially in order.

30. A system for providing a reward, the system comprising:
a first device which reproduces an advertisement;
a second device which transmits advertisement information based on the advertisement being reproduced by the first device; and
a third device for providing the reward, the third device comprising:
a first receiver configured to receive first advertisement information associated with the advertisement that is being reproduced in the first device, from the second device;
a first provider configured to provide, to the second device, a mission associated with the advertisement, based on the advertisement information;
a second receiver configured to receive, from the second device, a mission completion message; and
a second provider configured to provide the reward to at least one from among the first device and the second device, in response to the mission completion message.
